(19) United States
(12) Patent Application Publication
(10) Pub. No.: US 2011/0263735 A1
(43) Pub. Date: Oct. 27, 2011

(54) LIGHTWEIGHT MICROCELLULAR POLYAMIDE SHAPED ARTICLES

(76) Inventor: Gérard Bradley, Saronno (IT)

(21) Appl. No.: 12/526,524

(22) PCT Filed: Feb. 21, 2008
(86) PCT No.: PCT/EP08/52133

§ 371 Date: Mar. 2, 2011

(30) Foreign Application Priority Data
Feb. 23, 2007 (FR) 070301

(51) Int. Cl. C08K 3/28; C08J 9/10; B29C 44/16; C08K 3/40

(52) U.S. Cl. 521/95; 521/91; 264/51

(57) ABSTRACT

Optionally reinforced, lightweight microcellular polyamide shaped articles, e.g., automotive body or interior parts, are produced by injection molding a polyamide matrix in the presence of a fluid in the supercritical state.

The present invention relates to optionally reinforced microcellular polyamide articles. The invention also relates to a process for manufacturing these articles and also to the use of these light articles in various applications.

### PRIOR ART

Among the properties that it is often desired to improve for a polyamide material intended to be formed by various techniques, especially by injection molding, mention is made of the stiffness, the impact resistance, the dimensional stability, in particular at relatively high temperature, the low shrinkage after forming, the surface appearance, the density and the weight. The choice of a material for a given application is generally guided by the performance level required with respect to certain properties and by its cost. Specifically novel materials capable of meeting specifications in terms of performance and/or costs are always sought.

In particular, it is sought to produce polyamide articles that have a reduced weight especially for their application in the automotive field.

In order to obtain light and high-performance polyamide articles, it is known to use polyamide foams. In order to do this chemical routes or physical routes are conventionally used. Such a process is generally known under the name FIM, for foam injection molding. For this purpose, mention may be made of the few considerations of U.S. Pat. No. 5,158,986.

One of the most widely used methods consists in incorporating a supercritical fluid (SCF), during the injection-molding process, into a polymer in the melt state under pressure, especially in the plasticizing cylinder or in the injection nozzle. A supercritical fluid is a material that is maintained at a temperature that exceeds its critical temperature Tc and at a pressure that exceeds its critical pressure Pc. Supercritical fluids and the features thereof are well known and are mentioned, in particular, in the following publication: “Microcellular Processing”: K. T. Okamoto, C. Hanser Verlag, Munich 2003, page 6. Under the influence of a high pressure in a suitable injection-molding device, the supercritical fluid is soluble in the molten plastic (see, in particular, “Supercritical carbon dioxide in polymer reaction engineering” Ed. Maartje F. Kemmere, Thierry Meyer. Wiley-VCH Verlag GmbH & Co. KGaA. 2005, page 6). During the injection of the polymer into the molding chamber, a rapid reduction in the pressure then results in a thermodynamic instability which leads to a drop in the solubility of said fluid in the molten polymer. This reduction in the solubility of the supercritical fluid induces a nucleation and the growth of cells, and thus the formation of a microcellular material of foam type.

The articles thus molded are light and it is perfectly possible to control the mass and the density of the final article as a function of the amount of polymer used and injected into the mold. Specifically, the supercritical fluid allows the formation of cells which occupy the volume in the mold that is lacking material. For example, in order to obtain a 10% reduction in the weight, 10% less polyamide material is injected into the molding chamber.

However, in the case of polyamide, it appears that such a process leads to the formation of a microcellular article that has a poor surface appearance, in the absence or in the presence of reinforcing fillers. Specifically, areas of whitening on the surface, roughnesses and a loss of shine and reflectivity are observed. This poor surface appearance can be directed correlated to the method of forming microcellular articles using a supercritical fluid.

A poor surface appearance of these articles means they are unable to be used for esthetic parts, especially in the automotive or household sector.

There is thus a need to produce light microcellular polyamides that have a good compromise of mechanical properties and a satisfactory surface appearance, comparable to that which it is possible to obtain with a conventional injection-molding process.

### INVENTION

The Applicant has quite surprisingly found that the use of a polyamide having a high melt flow in an injection-molding process using a supercritical fluid for producing light microcellular polyamide articles made it possible to overcome the aforementioned drawbacks. Indeed, such a use makes it possible to obtain articles that have a very satisfactory surface appearance, comparable to that which may be obtained with a conventional injection-molding process. The process furthermore has the advantage of being simple to implement and does not require the use of other specific chemical foaming additives which may be expensive or may contribute to the reduction of the rheological and mechanical properties of the polyamide composition.

The present invention thus relates to the use of a composition comprising at least one polyamide matrix and optionally additives, in or for the manufacture of a microcellular polyamide article by injection molding using a fluid in the supercritical state;

said polyamide composition having an apparent melt viscosity according to the following relationships:

η100≦12.82(X)+239

η1000≦3.62(X)+139

in which η is the apparent melt viscosity of the polyamide composition measured at a temperature of 15° C. above the melting point of the polyamide composition; either at a shear rate of 100 s⁻¹, η100, or at a shear rate of 1000 s⁻¹, η1000; and X corresponds to the weight proportion of additives dispersed heterogeneously in the polyamide matrix, relative to the total weight of the composition.

The invention also relates to a formulation in the melt state comprising at least one composition comprising at least one polyamide matrix and optionally additives, having an apparent melt viscosity according to the relationships mentioned previously, and a fluid in the supercritical state. The present invention especially relates to a formulation in the melt state capable of being obtained by melt blending of a composition comprising at least one polyamide matrix and optionally additives, having an apparent melt viscosity according to the relationships mentioned previously, and a fluid in the supercritical state.

Such a formulation exists, in particular, under pressure in the plasticizing cylinder of the process for manufacturing a microcellular polyamide article by injection molding.

The invention also relates to a process for manufacturing a microcellular polyamide article by injection molding comprising at least the following steps:
a) producing a formulation in the melt state by blending a composition comprising at least one molten polyamide matrix and optionally additives, having an apparent melt viscosity according to the relationships mentioned previously, with a fluid in the supercritical state, so as to dissolve said fluid in the supercritical state in the matrix;
b) injecting the formulation obtained in the molding chamber of the injection-molding device by subjecting said composition to a drop in pressure in order to provoke nucleation and growth of cells; and
c) letting the mixture obtained solidify as a microcellular polyamide article in the molding chamber.

The polyamide of the invention is especially chosen from the group comprising the polyamides obtained by polycondensation of at least one aliphatic carboxylic diacid with an aliphatic or cyclic diamine such as PA-6,6, PA-6,10, PA-6,12, PA-12,12, PA-4,6, MXD 6 or between at least one aromatic carboxylic diacid and an aliphatic or aromatic diamine such as polyterephthalamides, polyisophthalamides, polyaramids, or a mixture and (co)polyamides thereof. The polyamide of the invention may also be chosen from the polyamides obtained by polycondensation of at least one amino acid or lactam with itself, the amino acid possibly being generated by the hydrolytic opening of a lactam ring such as, for example, PA-6, PA-7, PA-11, PA-12, or a mixture and (co)polyamides thereof.

According to one preferred mode of the invention, the low apparent viscosity of the composition according to the invention, according to the relationships mentioned previously, is due to the use of a polyamide matrix having a low apparent viscosity.

Low viscosity polyamides may especially be obtained by controlling their molecular weight during their synthesis, and therefore their melt fluidity, especially by addition, before or during the polymerization of the polyamide monomers, of monomers that modify the length of the chains, such as in particular diamines, carboxylic diacids, monoamines and/or carboxylic monoacids.

Polyamides according to the invention may also be obtained by blending, especially melt blending, of polyamides with monomers that modify the length of the chains, such as in particular diamines, carboxylic diacids, monoamines and/or carboxylic monoacids. It is possible, in particular, to add to the polyamide isophthalic acid or benzoic acid, for example in amounts of around 0.2 to 0.5% by weight.

The composition of the invention may also comprise copolyamides derived, in particular, from the above polyamides, or blends of these polyamides or (co)polyamides.

Particularly preferred polyamides are:
polyamide PA-6,6;
polyamide PA-6,6, in particular modified by addition to the synthesis of a carboxylic monoacid, such as acetic acid or benzoic acid;
the copolyamide PA-6,6/6, especially modified by addition to the synthesis of a carboxylic monoacid, such as acetic acid or benzoic acid;
the polyamide PA-6,6 modified by addition, in the melt state, of a carboxylic monoacid or diacid; and
the polyamide PA-6.

It is also possible to use, as a polyamide of high flow, a star polyamide comprising star macromolecular chains and, where appropriate, linear macromolecular chains. The polymers comprising such star macromolecular chains are, for example, described in documents WO 97/24388 and WO 99/64496.

These star polyamides are especially obtained by polymerization blending, in the presence of polyamide monomers, an amino acid or lactam such as caprolactam, of at least one multifunctional compound comprising at least 3 identical reactive functions of amine function or carboxylic acid function type. The expression “carboxylic acid” is understood to mean carboxylic acids and derivatives thereof, such as acid anhydrides, acid chlorides and esters, for example. The term “amine” is understood to mean amines and derivatives thereof capable of forming an amide bond.

It is possible, in particular, to use branched polyamides of high flow especially obtained by polymerization blending, in the presence of polyamide monomers, of at least one multifunctional compound comprising at least 3 identical reactive functions of amine function or carboxylic acid function type.

Preferably, the multifunctional compounds are chosen from the group comprising: 2,2,6,6-tetrakis-(β-carboxyethyl)cyclohexanone, trimesic acid, 2,4,6-tri(aminocaproic acid)-1,3,5-triazine and 4-aminoethyl-1,8-octanediamine.

The composition according to the invention may comprise between 30 and 90% by weight, preferably between 40 and 80% by weight, of polyamide relative to the total weight of the composition.

It is possible, in particular, to use, according to the present invention, polyamides having delayed crystallization kinetics. It is possible, in particular, to use well-known additives that will reduce the crystallization kinetics of the polyamide, such as, in particular, nigrosine. It is also possible to add polyamides or copolyamides that will reduce the crystallization temperature of the polyamide.

The apparent melt viscosity of the polyamide composition may be measured according to the ISO 11443 standard, in particular by using a Gattfert Rheograph 2002 capillary rheometer. It is possible, for example, to use a capillary having a length of 30 mm and a diameter of 1 mm.

The apparent melt viscosity of the polyamide composition is measured at a temperature of 15° C. above the melting point of the polyamide composition. The melting point of the polyamide composition may be measured by “METTLER DSC 20” DSC, according to the ISO 11357-3 standard, with a temperature rise of 10° C./min. Thus, for example, for a composition based on polyamide PA-6 having a melting point of 220° C., the apparent melt viscosity will be measured at a temperature of 235° C.

As explained previously, the polyamide composition may comprise additives dispersed heterogeneously in the polyamide matrix. The expression “additives dispersed heterogeneously in the polyamide matrix” is understood in the sense of the invention to mean polymeric or non-polymeric organic or inorganic solid additives that are dispersed in the continuous phase of the polyamide.

These additives are said to be dispersed heterogeneously insofar as they are not dissolved in the continuous phase of the polyamide.

X may, for example, be between 0.1 and 70% by weight, relative to the total weight of the composition, preferably between 10 and 60% by weight, more preferably between 15 and 50% by weight.

The additives according to the invention may especially be reinforcing and bulking fillers chosen from the group comprising glass fibers, carbon fibers, or mineral fillers such as kaolin, calcium carbonate, talc or wollastonite, glass beads, glass powder, or else exfoliable or non-exfoliable nanofillers. The weight concentration of the reinforcing fillers is advantageously between 0.1% and 50% by weight relative to the total weight of the composition, preferably between 10 and 40% by weight.

Short or long glass fibers may especially be added to the polyamide in order to produce the composition according to the invention.

The additives may also be agents that modify the impact resistance, such as, in particular, terpolymers of ethylene, acrylic ester and glycidyl methacrylate, copolymers of ethylene and butyl ester acrylate, copolymers of ethylene, n-butyl acrylate and glycidyl methacrylate, copolymers of ethylene and maleic anhydride, copolymers of ethylene, propylene and maleic anhydride, styrene/maleimide copolymers grafted with maleic anhydride, styrene/ethylene/butylene/styrene copolymers modified with maleic anhydride, maleic anhydride-grafted styrene/acrylonitrile copolymers, and maleic anhydride-grafted acrylonitrile/butadiene/-styrene copolymers. The weight concentration of elastomer is advantageously between 0.1 and 15% relative to the total weight of the composition.

The additives dispersed heterogeneously may also be polymers, such as polyolefins, polyesters, polyethers, polyether block amides, polyphenylene ethers, polyphenylene sulfides, acrylonitrile-butadiene-styrenes (ABS) or polystyrenes, especially syndiotactic polystyrenes, used to form an alloy of polyamide and of one or more of said polymers.

The heterogeneously dispersed additives of the invention may also be organic or inorganic flame-retardant compounds, such as, in particular, halogenated derivatives, such as bromostyrenes, derivatives of melamine, such as melamine cyanurate or melamine polyphosphate, red phosphorus, metal salts of alkyl phosphinates, magnesium hydroxide, Sb₂O₃ and zinc borate.

When several heterogeneously dispersed additives are present in the polyamide composition, their proportion by weight is added for the value of X in the relationships defined previously.

For example, for a polyamide composition comprising 30% by weight of heterogeneously dispersed additives, the apparent melt viscosity not to be exceeded is 624 Pa·s for a shear rate of 100 s⁻¹ (η100), and 248 Pa·s for a shear rate of 1000 s⁻¹ (η1000).

The compositions of the invention may also comprise all the additives commonly used in the polyamide-based compositions used for the manufacture of molded articles. Thus, mention may be made, by way of example of additives, of heat stabilizers, UV stabilizers, antioxidants, lubricants, pigments, dyes, plasticizers or impact modifiers. By way of example, the antioxidants and the heat stabilizers are, for example, alkali metal halides, copper halides, sterically hindered phenyl compounds and aromatic amines. The UV stabilizers are generally benzotriazoles, benzophenones or HALS.

The term “nucleation” is understood to mean the transient state when the fluid in the supercritical state is in the gas state, following the drop in pressure, in the form of bubbles in suspension in the molten polyamide. Nucleation may be obtained by subjecting the fluid composition comprising the polyamide and the fluid in the supercritical state to a rapid thermodynamic instability, caused for example by a drop in the temperature and/or pressure. The reduction in the solubility of the supercritical fluid induces a nucleation and the growth of cells, and thus the formation of a foam-type microcellular material.

As the fluid in the supercritical state, use is preferably made of carbon dioxide and nitrogen N₂. Mention may especially be made, for this purpose, of the publication by R. Lacallade, Plastics Engineering, vol. 32, June 1976, pp. 40-42, the reference Supercritical Carbon Dioxide in Polymer Reaction Engineering, edited by M. F. Kemmere and T. Meyer, WILEY-VCH, 2005, pp. 3-6, and U.S. Pat. No. 3,796,779.

Preferably between 0.01 and 3% by weight, preferably between 0.01 and 1% by weight, more preferably between 0.05 and 0.5% by weight, of fluid in the supercritical state is used relative to the total weight of the formulation.

In order to carry out the process of the invention, it is possible to use a suitable injection-molding device comprising, for example, a plasticizing cylinder, the pressure of which can be controlled, connected to one or more pressurized gas injectors. The fluid in the supercritical state may especially be added to the polyamide in the melt state in the plasticizing cylinder or else at the nozzle of the plasticizing cylinder, just before the injection into the mold.

Such a device is constructed and arranged in order to subject the molten formulation to a sufficient pressure drop to cause the nucleation and the growth of the cells, while making this composition pass into the molding chamber. These devices are well known in the field and mention may be made, by way of example, of application EP 1 264 672 relating to such a device.

The fluid in the supercritical state is generally dispersed and dissolved in the molten matrix.

The injection speed during the injection-molding process for producing microcellular articles is generally higher than the speed conventionally used for standard injection-molding processes.

It should be noted that the molding chamber may be constructed in order to contain the formulation at a high pressure so as to control the growth of the cells.

The temperature of the mold, in the molding chamber, is preferably between 20 and 120° C., more preferably between 50 and 120° C.

The light articles obtained according to the invention generally comprise closed cells in particular having a diameter between 1 and 100 μm, preferably between 1 and 50 μm. The proportion of void volume in the microcellular article may be between 2 and 50%, preferably between 2 and 40%, more preferably between 2 and 30%, in particular between 5 and 15%, relative to the total volume.

The articles of the invention may be, for example, articles for the automotive industry, in particular for the manufacture of body or interior parts, electric or electronic components and accessories for various activities such as sporting activities for example.

A specific language is used in the description so as to facilitate the understanding of the principle of the invention. It should nevertheless be understood that no limitation of the scope of the invention is envisaged by the use of this specific language. Modifications, improvements and developments may especially be envisaged by a person acquainted with the technical field in question on the basis of his own general knowledge.

The term “and/or” includes the meanings and, or and also all the other possible combinations of the elements connected to this term.

Other details or advantages of the invention will appear more clearly in light of the examples given below solely by way of indication.

### EXPERIMENTAL SECTION

### Example 1

### Manufacture of the Articles

The compounds used in the present experimental section were the following:
Glass fibers for extrusion having a length of 4.5 mm and a diameter of 10 μm.
Additives: dyes, stabilizers and molding aids.
PA1: star polyamide PA-6 obtained by copolymerization from caprolactam in the presence of 0.05 mol % of 2,2,6,6-tetrakis(β-carboxyethyl)cyclo-hexanone and 0.45 mol % of adipic acid, according to application WO 99/64496.
PA2: linear polyamide PA-6,6 of low fluidity, obtained by addition, in the polymerization, of 0.075% by weight of acetic acid.
PA3: linear copolyamide PA-6,6/6 (90%/10% by weight) of low fluidity, obtained by addition, in the polymerization, of 0.06% by weight of acetic acid.
PA4: linear polyamide PA-6,6 having the following contents of end groups: TAG=45 meq/kg, TCG=65 meq/kg.
PA5: polyamide obtained by blending PA4, 12% by weight of polyamide PA-6 and 0.35% by weight of isophthalic acid, in an extruder for the manufacture of granules.
PA6: polyamide PA-6, having a relative viscosity of 145 according to the ISO 307 standard (90% formic acid).
PA7: star polyamide PA-6 obtained by copolymerization from caprolactam in the presence of 0.46 mol % of 2,2,6,6-tetrakis(β-carboxyethyl)cyclo-hexanone, according to application WO 97/24388.

Granules of polyamide compositions were obtained using a conventional twin-screw extruder of Werner & Pfleiderer ZSK 40 type with a rotational speed of the screws of 240 rpm and an output rate of 40 kg/h, so as to blend the polyamide, glass fibers and approximately 1% by weight of conventional additives. Said additives are homogeneously dissolved in the polyamide.

Temperature profile in degrees Celsius:
for the polyamides of PA-6 type: Zone 1: 230; Zone 2: 235; Zone 3: 235; Zone 4: 240; Zone 5: 240; Zone 6: 240; Zone 7: 245; Zone 8: 245 and
for the polyamides of PA-6,6 type: Zone 1: 250; Zone 2: 260; Zone 3: 260; Zone 4: 260; Zone 5: 270; Zone 6: 270; Zone 7: 270; Zone 8: 280.

For the polyamide formulations comprising 30% by weight of heterogeneously dispersed additives, glass fibers, the apparent melt viscosity not to be exceeded was 624 Pa·s for a shear rate of 100 s⁻¹ (η100), and 248 Pa·s for a shear rate of 1000 s⁻¹ (η1000).

For the production of microcellular articles for which it is desired to assess the surface appearance, a Krauss Maffei KM650/3500 C2 machine having a diameter of 80 mm was used to manufacture articles of around 500 g; with the following parameters:
for the polyamides of PA-6 type: temperature profile of the plasticizing cylinder of 230-260° C., mold temperature of 80° C., injection speed of 45-30 mm/s.
for the polyamides of PA-6,6 type: temperature profile of the plasticizing cylinder of 260-290° C., mold temperature of 80° C., injection speed of 45-30 mm/s.

For the production of microcellular articles for which it is desired to assess the mechanical properties, the following injection-molding process was used for manufacturing articles of around 50 g:

An Arburg 420S machine was used.

For the polyamides of PA-6 type: temperature of the plasticizing cylinder of 265° C., mold temperature of 80° C. For the polyamides of PA-6,6 type: temperature of the plasticizing cylinder of 285° C., mold temperature of 100° C. The injection speed is 16 cm/s.

In the two manufacturing processes, around 0.3% by weight of fluid N₂ in the supercritical state was introduced into the molten polymer during the plasticizing phase in the screw of the injection-molding machine, via gas injectors. The pressure in the extruder was at least 100 bar.

### Example 2

### Measurement of the Properties of the Articles

The final compositions of the articles, their rheological properties and their surface appearances are mentioned in Table 1. The mechanical properties are listed in Table 2. The percentages (%) in the compositions are by weight relative to the total weight of the composition.

TABLE 1

| Samples | C1 | C2 | 3 | 4 | 5 | 6 | 7 |
|---|---|---|---|---|---|---|---|
| Polyamide | PA4 | PA6 | PA2 | PA5 | 33% PA2 + | PA1 | PA7 |
| | | | | | 30% PA3 | | |
| Glass | 30 | 30 | 30 | 30 | 30 | 30 | 30 |
| fibers (%) | | | | | | | |
| Reduction | 10 | 10 | 10 | 10 | 10 | 10 | 10 |
| in weight | | | | | | | |
| (%) | | | | | | | |
| Properties | | | | | | | |
| η100 | 791 | 996 | 417 | 402 | 410 | 484 | 820 |
| η1000 | 299 | 360 | 160 | 150 | 148 | 205 | 253 |
| Melting | 263 | 222 | 263 | 258 | 258 | 222 | 222 |
| point (° C.) | | | | | | | |
| Surface | poor | poor | good | very | very | very | good |
| appearance | | | | good | good | good | |

TABLE 2

| Samples | C1 | 3 | 4 | 5 | 6 |
|---|---|---|---|---|---|
| Polyamide | PA4 | PA2 | PA5 | 33% PA2 + | PA1 |
| | | | | 30% PA3 | |
| Glass fibers (%) | 35 | 35 | 35 | 35 | 35 |
| Reduction in weight (%) | 10 | 10 | 10 | 10 | 10 |
| Charpy unnotched impact | 66 | 54 | 66 | 56 | 62 |
| (kJ/m²) | | | | | |
| Tensile strength (N/mm²) | 152 | 150 | 152 | 153 | 146 |
| Tensile modulus (N/mm²) | 9320 | 9260 | 8890 | 9290 | 9480 |

The properties of the articles were evaluated as follows:
tensile strength according to the ISO 527 standard
elongation at break according to the ISO 527 standard
tensile modulus according to the ISO 527 standard
Charpy unnotched impact strength according to the ISO 179/1eU standard
melting point according to the ISO 1137-3 standard (“METTLER DSC 20” DSC, with a temperature rise of 10° C./min)
apparent melt viscosity measured according to the ISO 11443 standard
surface appearance according to a visual assessment in order to determine whether the surface appearance is good or poor. It is considered to be poor when zones of whitening and roughnesses are observed at the surface.

In all cases, the reduction in the weight of the article, relative to an article obtained by a conventional injection-molding process is of the order of 10%.

1.-13. (canceled)

14. A composition comprising at least one polyamide matrix and, optionally, additives therefor, convertible into a microcellular polyamide shaped article by injection molding employing, and containing therein, a fluid in the supercritical state;
said polyamide composition having an apparent melt viscosity according to the following relationships:
η100≦12.82(X)+239
η1000≦3.62(X)+139
in which:
η is the apparent melt viscosity of the polyamide composition measured at a temperature of 15° C. above the melting point of the polyamide composition; either at a shear rate of 100 s⁻¹, η100, or at a shear rate of 1000 s⁻¹, η1000; and X corresponds to the weight proportion of additives dispersed heterogeneously in the polyamide matrix, relative to the total weight of the composition.

15. The composition as defined by claim 14, wherein the polyamide is selected from the group consisting of the polyamides obtained by polycondensation of at least one linear aliphatic carboxylic diacid with an aliphatic or cyclic diamine or from at least one aromatic carboxylic diacid and an aliphatic or aromatic diamine, the polyamides obtained by polycondensation of at least one amino acid or lactam, or a mixture and (co)polyamides thereof.

16. The composition as defined by claim 14, wherein the polyamide has delayed crystallization kinetics.

17. The composition as defined by claim 14, wherein the polyamide is obtained by addition, before or during the polymerization of the polyamide monomers, of monomers of diamine, carboxylic diacid, monoamine and/or carboxylic monoacid types.

18. The composition as defined by claim 14, wherein the polyamide is obtained by blending, optionally melt blending, of a polyamide with monomers that modify the length of the chains, comprising diamines, carboxylic diacids, monoamines and/or carboxylic monoacids.

19. The composition as defined by claim 14, wherein the polyamide is a star polyamide comprising star macromolecular chains and, optionally, linear macromolecular chains.

20. The composition as defined by claim 19, wherein the star polyamide is obtained by polymerization blending, in the presence of polyamide monomers, of at least one multifunctional compound comprising at least 3 identical reactive amine or carboxylic acid functions.

21. The composition as defined by claim 14, comprising additives dispersed heterogeneously in the polyamide matrix and including polymeric or non-polymeric, organic or inorganic solid additives.

22. The composition as defined by claim 14, comprising additives dispersed heterogeneously in the polyamide matrix and including reinforcing or bulking fillers, agents that modify the impact resistance of polymers, polymers, and/or flame-retardant compounds.

23. The composition as defined by claim 14, wherein the supercritical fluid is selected from the group consisting of carbon dioxide and nitrogen.

24. A formulation in the melt state comprising at least one composition including at least one polyamide matrix, optionally, additives therefor, and having an apparent melt viscosity as defined by claim 14.

25. A formulation in the melt state obtained by melt blending of a composition comprising at least one polyamide matrix, optionally, additives therefor, and having an apparent melt viscosity as defined by claim 14.

26. A process for producing a lightweight microcellular polyamide shaped article by injection molding comprising at least the following steps:
a) providing a formulation in the melt state by blending a composition comprising a polyamide matrix and, optionally, additives therefor, having an apparent melt viscosity as defined by claim 14, with a fluid in the supercritical state; to dissolve said fluid in the supercritical state in said matrix;
b) injecting the formulation obtained in the molding chamber of an injection-molding device by subjecting said composition to a drop in pressure to provoke nucleation and growth of cells; and
c) permitting the mixture obtained to solidify as a lightweight microcellular polyamide shaped article in the molding chamber.

27. A lightweight microcellular polyamide matrix shaped article produced by injection molding the composition as defined by claim 14.

28. A lightweight microcellular polyamide matrix shaped article produced by the process as defined by claim 26.
